(19) United States
(12) Patent Application Publication
(10) Pub. No.: US 2026/0115832 A1
(43) Pub. Date: Apr. 30, 2026

(54) METHOD AND APPARATUS FOR PROCESSING WORKPIECE BY USING LASER

(71) Applicant: ORC MANUFACTURING CO., LTD., Tokyo (JP)

(72) Inventors: Masahiko FUNAYAMA, Tokyo (JP); Masaru YAMAGA, Tokyo (JP)

(73) Assignee: ORC MANUFACTURING CO., LTD., Tokyo (JP)

(21) Appl. No.: 19/066,774

(22) Filed: Feb. 28, 2025

(30) Foreign Application Priority Data
Oct. 30, 2024 (JP) 2024-190573

(51) Int. Cl. B23K 26/06; B23K 26/082; B23K 26/36

(52) U.S. Cl. CPC B23K 26/0661; B23K 26/0626; B23K 26/082; B23K 26/36

(57) ABSTRACT

A method for processing a workpiece by laser ablation, which includes: a) preparing a mask with a plurality of mask patterns, the plurality of mask patterns having widths corresponding to a sub-scanning direction, the widths being different from one another; b) scanning a line-shaped laser beam over said mask; c) projecting a pattern beam that passes through the mask onto a workpiece; and d) processing a processing area of the workpiece by using the plurality of mask patterns repeatedly to form a processed pattern at the bottom of the processing area.

### BACKGROUND OF THE INVENTION

### 1. Field of the Invention

The present invention relates to a laser-processing unit, and especially, a laser-processing method and a mask pattern used for the laser process.

### 2. Description of the Related Art

As for a substrate such as a printed wiring board, an accurately formed fine pattern is required for miniaturization of electronic equipment and high-density mounting onto a semiconductor. For example, the formation of a precision via hole or groove (trench) at the micron level is required for a multilayer substrate.

Suwa et al. (US 2021/0046584A1) discloses a laser ablation process (also called photoablation) that is one laser beam processing method. In the laser ablation, a laser beam with high energy density is formed and a scanner scans the laser beam over a fixed mask or reticle to project an image on a substrate or the like. By removing material from the surface of the substrate instantaneously in accordance with patterns formed on the mask or the reticle, a via hole or trench can be formed on the substrate. Misaka (US7, 790, 337B2) discloses a photomask in which a plurality of different mask patterns is formed.

### SUMMARY OF THE INVENTION

A method for processing a workpiece by laser ablation includes: a) preparing a mask with a plurality of mask patterns, the plurality of mask patterns having widths corresponding to a sub-scanning direction, the widths being different from one another; b) scanning a line-shaped laser beam onto the mask; c) projecting a pattern beam that passes through the mask onto a workpiece; and d) processing a processing area of the workpiece by using the plurality of mask patterns repeatedly to form a processed pattern in the processing area, in which the bottom of the processing area is flat.

A mask according to another aspect of the present invention includes a rectangular first mask pattern and a rectangular second mask pattern. The first mask pattern and the second mask pattern are aligned in a predetermined direction. The length of the second mask pattern is equal to that of the first mask pattern in the predetermined direction, whereas the width of the second mask pattern is different from that of the first mask pattern in a direction perpendicular to the predetermined direction. The width of the second mask pattern is narrower than that of the first mask pattern by a length corresponding to a ringing appearing in a pattern beam that passes through the mask.

An apparatus for processing a workpiece by laser ablation according to another aspect of the present invention includes: a light source; an illumination optical unit configured to form a line-shaped laser beam from a laser beam oscillated from the light source; a mask stage configured to support the mask and move the mask along a main scanning direction and a sub-scanning direction. The mask has a rectangular first mask pattern and a rectangular second mask pattern. The apparatus furthermore includes: a scanner configured to scan the line-shaped laser beam; a projection optical system configured to project a pattern beam that passes through the mask onto the workpiece; a processing stage configured to move the workpiece along the main scanning direction and the sub-scanning direction; and a controller configured to control the light source, the scanner, the mask stage and the processing stage. The width of the second mask pattern is narrower than that of the first mask pattern by a length corresponding to a ringing appearing in the pattern beam. The controller carries out laser ablation in a processing area of the workpiece repeatedly to form a processed pattern with a flat surface in the processing area by controlling the mask stage and the processing stage.

A method for processing a workpiece by laser ablation according to another aspect of the present invention includes: a) preparing a mask with a plurality of mask patterns, the plurality of mask patterns having widths between pattern edges intersecting a direction corresponding to a sub-scanning direction, the widths of the plurality of mask patterns being different from one another, the plurality of mask patterns being geometrically similar to one another; b) scanning a line-shaped laser beam over the mask; c) projecting a pattern beam that passes through the mask onto a workpiece; and d) processing a processing area in the workpiece by using the plurality of mask patterns repeatedly to form a processed pattern with a flat surface in the processing area.

### BRIEF DESCRIPTION OF THE DRAWINGS

The present invention will be better understood from the description of the preferred embodiment of the invention set forth below together with the accompanying drawings, in which:

FIG. 1 is a schematic plan view showing a laser-processing unit according to one embodiment; and

FIG. 2 is a schematic block diagram of the laser-processing unit;

FIG. 3 is a view showing a mask pattern;

FIG. 4A is a view showing a first mask pattern and a second mask pattern;

FIG. 4B is a view showing a substrate cross-section that is processed by a line-beam;

FIG. 5 is a view showing an intensity distribution of an optical image of a pattern beam; and

FIG. 6 is a flow of a laser ablation process.

### DESCRIPTION OF THE PREFERRED EMBODIMENTS

Hereinafter, the preferred embodiment of the present invention is described with references to the attached drawings.

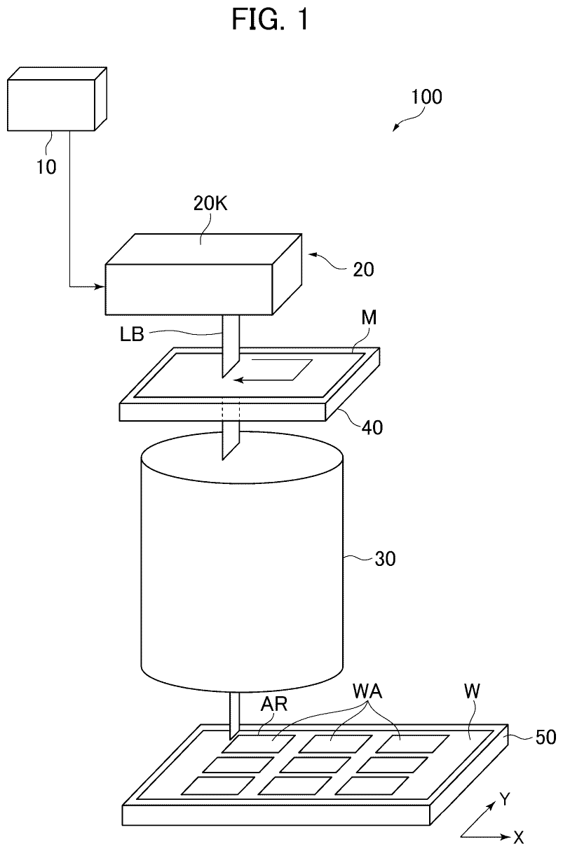

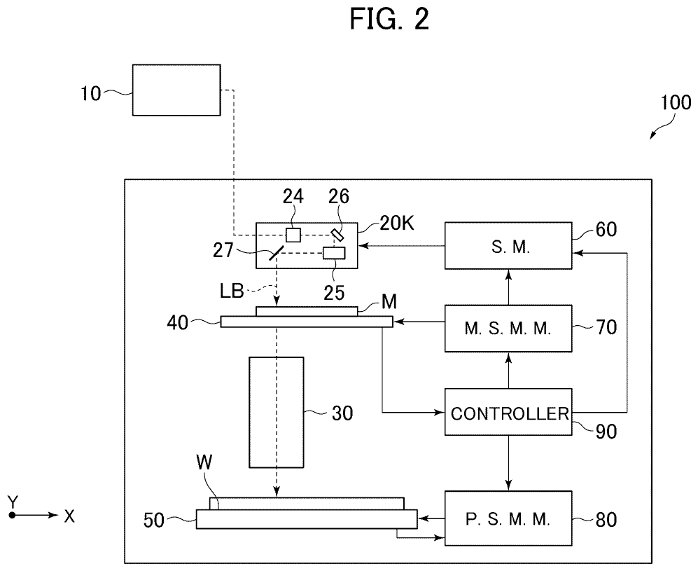

FIG. 1 is a schematic view showing a laser-processing unit according to the present embodiment. FIG. 2 is a schematic block diagram of the laser-processing unit according to the present embodiment.

A laser-processing unit or machine 100 forms a pattern on a substrate W by laser ablation and is equipped with a line-beam forming unit (illumination optical unit) 20, a projection optical system 30, a mask stage 40, and a processing stage 50, which are supported by a body (not shown). The line-beam forming unit 20, the mask stage 40 and the processing unit 50 are movable with respect to the body. A mask M and a substrate W are mounted on the mask stage 40 and the processing stage 50, respectively. The substrate W is herein a resin substrate such as a printed substrate.

The laser 10 is arranged adjacent to the body and oscillates a laser beam with high energy density. Herein, the laser 10 is an excimer laser that emits a KrF excimer laser beam with a wavelength of 248 nm. A laser beam oscillated from the laser 10 is directed to the line-beam forming unit 20 via a correcting optical system that adjusts an axis of the laser beam (not shown). Note that the laser source 10 may or may not be part of the laser-processing unit 100.

The line-beam forming unit (illumination optical unit 1) 20 is equipped with a line-beam forming optical system 25 including a lens array 24 and a cylindrical lens (not shown), angle switching mirrors 26 and 27, etc. The lens array 24 adjusts the distribution of the intensity of the incident laser beam. The line-beam forming optical system 25 forms a line-shaped laser beam LB from the luminous flux of the laser beam L that enters the line-beam forming optical unit 30. For example, the line-beam forming optical system 25 may form a rectangular beam having a length in the longitudinal direction of “26 mm” and a width of “0.1 mm” as a line-shaped laser beam LB (hereinafter, called a “line-beam”).

The line-beam forming unit 20 has a casing 20K that contains the line-beam forming optical system 25, etc. The casing 20K is supported by a scanning mechanism 60. The scanning mechanism 60 shown in FIG. 2 moves the line-beam forming unit 20 along the main scanning direction at a given speed to move the line-beam LB relative to the mask M along the main scanning direction. Herein, the X axis and Y axis are defined along the main scanning direction and the sub-scanning direction, respectively.

The angle-switching mirror 26 switches a mirror angle to shift the position of the laser beam LB irradiating the mask M along the sub-scanning direction (the Y axis direction), i.e., it switches an irradiation area on the mask M. Herein, the angle-switching mirror 26 is arranged at a conjugate point that is between the lens array 24 and the line-beam forming optical system 25.

The mask stage 40 supports the mask M and moves the mask M along the main scanning direction (the X-axis direction) and the sub-scanning direction (the Y-axis direction). Furthermore, the mask stage 40 may rotate the mask M. A mask-stage moving mechanism 70 drives the mask stage 40 based on signals from a position-detecting sensor (not shown).

The projection optical system 30 has focus points on the surfaces of the mask M and the substrate W. The projection optical system 30 projects light that passes through the mask M to the substrate W as a light pattern. Herein, a projection magnification is defined to be 1.0. However, the projection optical system 30 may be a reduced-lens optical system, which has a projection magnification less than 1 (e.g., 0.5).

The processing stage 50 secures the substrate W with a vacuum adsorption process and moves the substrate W along the main scanning direction (the X-axis direction) and the sub-scanning direction (the Y-axis direction). The processing stage 50 may rotate the substrate W. A processing-stage moving mechanism 80 drives the processing stage 50 based on signals from a position-detecting sensor (not shown). An alignment camera (not shown) that images alignment marks formed on the substrate W is provided adjacent to the processing stage 50.

In the substrate W, a copper wiring layer is formed on an epoxy resin and an insulation layer is further formed on the copper wiring layer. As described above, the laser 10 emits the excimer laser beams with high energy density towards the substrate W, which ablates, i.e., removes material from the substrate W so that a pattern corresponding to a mask pattern (hereinafter, “processing pattern”) WA is formed on the substrate W. For example, an interstitial via hole, blind via hole, wiring groove (trench), etc., can be formed on the substrate W.

While the scanning mechanism 60 moves the line-beam forming unit 20 in the main scanning direction (the X-axis direction), the line beam LB perpendicular to the main scanning direction (the X-axis direction) and parallel to the sub-scanning direction (the Y-axis direction) moves relative to the mask M (the mask stage 40), the projection optical system 30, and the substrate W (the processing stage 50). Thus, the mask M mounted on the mask stage 40 and the substrate W mounted on the processing stage 50 are scanned.

The size of the mask pattern is based on the size of the processing area AR of the substrate W and an imaging magnification of the projection optical system 30. The entire area in which the mask pattern can be formed has a size larger than the width of the line-beam LB along the longitudinal direction, i.e., the Y-axis direction. The scanning along the X-axis direction is repeatedly carried out on the mask M as the angle-switching mirror 26 switches the irradiated position of the line-beam LB along the Y-axis direction. Thus, the entire processed pattern WA is formed in one processing area AR.

The processing stage 50 moves step by step along the main scanning direction (the X-axis direction) and the sub-scanning direction (the Y-axis direction) wherever the processed pattern WA is formed at each processing area AR so that the laser ablation is carried out for the entire substrate W. After the laser ablation is finished, the substrate W is filled with a conductor such as copper. Note that a mask pattern MA corresponding to the total area of the substrate W may be formed on the mask M.

A controller 90 controls the angle-switching mirror 26 in the line-beam forming unit 20, the scanning mechanism 60, the mask-stage moving mechanism 70 and the processing-stage moving mechanism 80, etc. Concretely, the controller 90 positions the mask M and the substrate W, moves the irradiating position of the line-beam LB along the main scanning direction (the X-axis direction), and shifts the irradiating position along the sub-scanning direction (the Y-axis direction).

The controller 90 controls the laser ablation process. The controller 90 drives the laser 10 and controls the scanning mechanism 60 to scan the line-beam LB along the main scanning direction (the X-axis direction) in accordance to an input operation by an operator. Furthermore, the controller 90 controls the movement of the mask stage 40 and the processing stage 50, adjusts the deviation of the optical axis of the laser beam L, carries out an alignment process using the alignment cameras, and controls the opening and closing of the shutter mechanism.

In this embodiment, two mask patterns, which are different from one another with respect to their widths along the sub-scanning direction (the Y-axis direction), are used while performing an ablation process repeatedly.

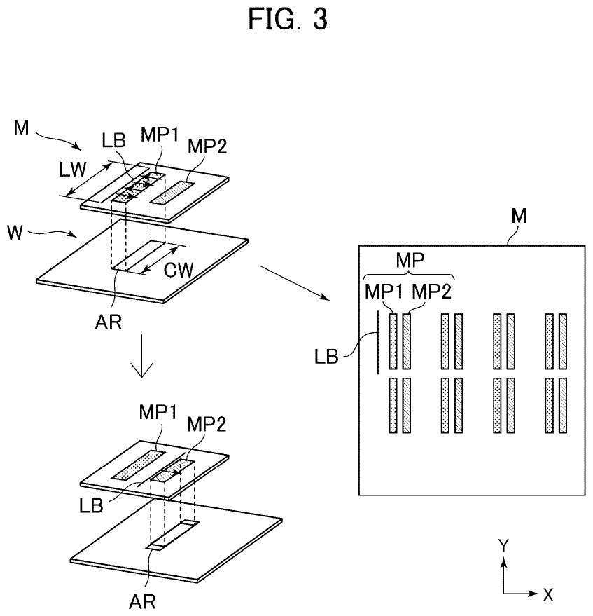

FIG. 3 is a view showing a mask pattern. A rectangular cavity is herein formed as a processed pattern WA.

In the mask M, a plurality of mask patterns is formed. Concretely, a plurality of mask patterns MP is regularly aligned along the sides of the mask M at given intervals. The mask pattern MP is composed of two rectangular mask patterns MP1 and MP2 (hereinafter, called a “first mask pattern” MP1 and a “second mask pattern” MP2, respectively), which are parallel to one another. The mask M is mounted on the mask stage 40 so that the first and second mask patterns MP1 and MP2 are aligned along the X and Y axis directions.

The widths of the first and second mask patterns, MP1 and MP2, along the main scanning direction (the X-axis direction) are longer than that of the line-beam LB along the main scanning direction (the X-axis direction). To form a cavity pattern on the entire processing area AR, the line-beam LB moves across the mask M along the main-scanning direction (the X-axis direction) and passes over the mask patterns MP.

When forming a cavity pattern in one processing area AR, laser processing is carried out multiple times over a processed area AR while the mask M and the substrate W are gradually moved along the X and Y directions. A laser ablation using only the first mask pattern MP1 is carried out as a first stage process, and a laser ablation using only the second mask pattern MP2 is carried out as a second stage process.

For example, laser ablation using four first mask patterns MP1 aligned along the main scanning direction (the X-axis direction) is carried out at the first stage process. After the mask M is shifted along the sub-scanning direction (the Y-axis direction), laser ablation using the remaining four first mask patterns MP1, which are aligned in the next line, is carried out at the second stage process. Similarly, a two-step laser ablations process using the eight second mask patterns MP2 is carried out.

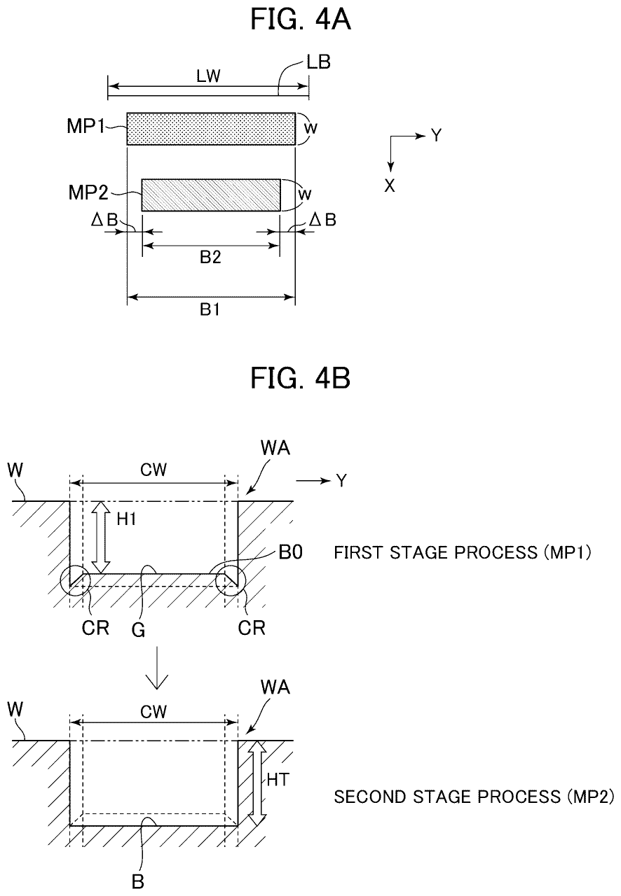

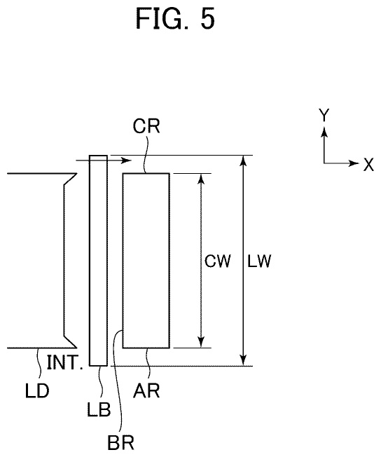

FIG. 4A is a view showing the first mask pattern MP1 and the second mask pattern MP2. FIG. 4B is a view showing a substrate cross-section that is processed by the line-beam LB. FIG. 5 is a view showing an intensity distribution of an optical image of the pattern beam LB when irradiating the substrate W with the line-beam LB.

The width “LW” of the line-beam LB, which reaches en the mask M, is greater than the width “B1” of the first mask pattern MP1 along the sub-scanning direction (the Y-axis direction). Part of the line-beam LB passes through the first mask pattern MP1 to irradiate the processing area AR as a pattern beam. The width “CW” of the processing area AR is herein the same as the width “B1” of the first mask pattern MP1 along the sub-scanning direction (the Y-axis direction).

The laser beam L is a pulse beam with high energy density and the line-beam LB formed by the line-beam forming unit 20 has a uniform intensity distribution. However, the intensity distribution of the line-beam LB after passing over the first mask pattern MP1 is not uniform since so-called “ringing” occurs in the intensity distribution.

FIG. 5 shows the intensity distribution of the pattern beam by numerical reference “LD”. Note that the magnitude of the intensity of the line-beam LB is represented in the main scanning direction (the X-axis direction). In the intensity distribution “LD”, local peaks at both edges appear because of the ringing.

In the laser ablation using the line-beam LB with the intensity distribution “LD” described above, a pattern beam with a high energy density continues irradiating the edges CR of the processing area during the AR scanning. Consequently, the edges CR are carved out or sharpened deeply compared to the other area G, and grooves are formed along the main scanning direction (the X-axis direction) (See FIG. 4B).

On the other hand, the edges “BR” of the processing area AR along the sub-scanning direction (the Y-axis direction) are formed by the pattern beam that reaches the processing area AR but does not maintain a high energy density level during the scanning. When the line-beam LB starts passing through the first mask pattern MP1, a pattern beam that is not formed as an image and has a lower intensity enters the processing area AR. The intensity of the pattern beam increases as the line-beam LB moves over the first mask pattern MP1 and decreases again when the line-beam LB passes through the first mask pattern MP1. Thereby, over-processing due to ringing does not occur in the edges “BR” of the processing area AR.

In this embodiment, the widths “w” of the first and second mask patterns MP1 and MP2 along the main scanning direction (the X-axis direction) are equal, whereas the width “B2” of the second mask pattern MP2 is less than the width “B1” of the first mask pattern MP1 in the sub-scanning direction (the Y-axis direction). (See FIG. 4A). Since the central position of the first and second mask patterns MP1 and MP2 along the sub-scanning direction (the Y-axis direction) is the same position, the second mask pattern MP2 is shorter than the first mask pattern MP1 by ΔB at each edge CR (Δ2B in total).

When carrying out laser ablation over the processing area AR by using the second mask pattern MP2, a pattern beam, which passes through the second mask pattern MP2, reaches the area G and the laser ablation is carried out over the area G, but it doesn't include the edges GR because the width “B2” of the second mask pattern MP2 is narrower than that of first the mask pattern MP1. Consequently, the bottom B of the processed pattern WA (i.e., cavity) is formed in the processing area AR with a flat surface.

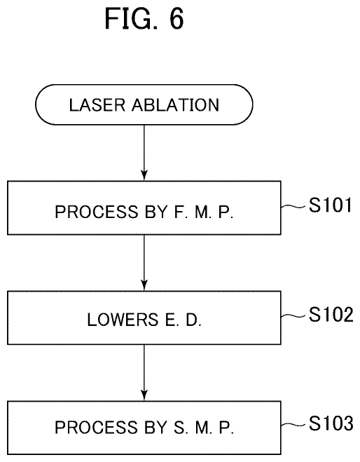

FIG. 6 is a flow of a laser ablation process.

In advance, the mask M with the first mask patterns MP1 and the second mask patterns MP2 are formed and prepared. In the first stage of the process, laser ablation using the first mask patterns MP1 is carried out (Step 101). As for the processed pattern WA, i.e., cavity, a final target depth “HT” is predetermined and the processing area AR is carved out or removed to the extent of the depth “H1” that is represented by a given ratio to the target depth “HT”. Herein, the ratio is determined to be 80 percentage of the target depth “HT”.

In the second stage of the process, laser ablation using the second mask patterns MP2 is carried out to carve out or remove the depth corresponding to the remaining 20 percent. Furthermore, the energy density of the laser beam L is lowered when irradiating the laser beam LB (Steps 102 and S103). Since the accumulated energy density (fluence) at the edges CR is lower than the remaining area G, the processed pattern WA with the flat bottom is formed.

When carrying out the laser ablation using the second mask pattern MP2, a ringing occurs in the intensity distribution of the pattern beam. However, any over-processing is relatively mild and not remarkable compared to the laser ablation using the first mask pattern MP1, because the energy density of the laser beam L is reduced for the second mask pattern MP2. As a result, the flat bottom B of the processed pattern WA is formed accordingly.

In the above explanation, all the mask patterns MP are used for the laser ablation. On the other hand, only some mask patterns may be selected to carry out a laser ablation. For example, laser ablation may be carried out by using several first mask patterns MP1, but only one mask pattern MP2 is used when carrying out the second stage process. Also, a laser ablation using one first mask pattern MP1 and one second mask pattern MP2 may be carried out, in order.

A mask pattern other than a rectangular pattern, such as a cavity, may be applied. A mask pattern such as a trapezoid, polygon, or long hole (slit) pattern may also be applied. Furthermore, a mask pattern having a contour line such as a curved line with curvature R or a free curve, etc., may be applied too.

In this case, plural mask patterns with widths that are different from one another in the sub-scanning direction (the Y-axis direction), but similar geometrically, may be formed on the mask M. When carrying out multiple laser ablation, the mask M is positioned in a standard starting position in each laser ablation before scanning is carried out. Thus, over-processing is suppressed.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2024-190573 (filed on Oct. 30, 2024), which is expressly incorporated herein by reference, in its entirety.

1. A method for processing a workpiece by laser ablation, comprising:
a) preparing a mask with a plurality of mask patterns, the plurality of mask patterns having widths corresponding to a sub-scanning direction, the widths being different from one another;
b) scanning a line-shaped laser beam over said mask;
c) projecting a pattern beam that passes through said mask onto a workpiece; and
d) processing a processing area in said workpiece repeatedly by using said plurality of mask patterns to form a processed pattern with a flat bottom in the processing area.

2. The method according to claim 1, wherein the forming step is accomplished by forming a first mask pattern on said mask and a second mask pattern onto said mask, the width of the second mask pattern being narrower than that of said first mask pattern by a length corresponding to a ringing appearing in the pattern beam.

3. The method according to claim 2, wherein the processing step is accomplished by processing the processing area using said first mask pattern and processing the processing area using said second mask pattern, in order, the processing step being accomplished by lowering the energy density of the laser beam when carrying out a second stage laser ablation using said second mask pattern compared to the energy density of the laser beam when carrying out a first stage laser ablation using said first mask pattern.

4. The method according to claim 2, wherein the processing step is accomplished by carrying out a first stage laser ablation that removes substances in the processing area at a depth less than a target depth by using said first mask pattern and carrying out a second stage laser ablation that t removes substances in the processing area at the target depth by using said second mask pattern.

5. The method according to claim 4, wherein the processing step is accomplished by carrying out the first stage laser ablation that removes substances in the processing area at a depth that is equal or greater than 80 percent of the target depth.

6. The method according to claim 1, wherein the forming step is accomplished by forming said first mask pattern and said second mask pattern in a single mask.

7. The method according to claim 6, wherein the forming step is accomplished by aligning a plurality of pairs of said first mask patterns and said second mask patterns in said single mask alternately and regularly.

8. The method according to claim 1, wherein the processing step is accomplished by forming a cavity on a substrate.

9. A mask comprising:
a rectangular first mask pattern; and
a rectangular second mask pattern, said first mask pattern and said second mask pattern being aligned in a predetermined direction, the length of said second mask pattern being equal to that of said first mask pattern in the predetermined direction, the width of said second mask pattern being different from that of said first mask pattern in a direction perpendicular to said predetermined direction, the width of said second mask pattern being narrower than that of said first mask pattern by a length corresponding to a ringing appearing in a pattern beam that passes through said mask.

10. An apparatus for processing a workpiece by laser ablation, comprising:
a light source;
an illumination optical unit configured to form a line-shaped laser beam oscillated from said light source;
a mask stage configured to support said mask and move said mask along a main scanning direction and a sub-scanning direction, said mask comprising a rectangular first mask pattern and a rectangular second mask pattern;
a scanner configured to scan the line-shaped laser beam over said mask;
a projection optical system configured to project a pattern beam that passes through said mask onto said workpiece;
a processing stage configured to move said workpiece along the main scanning direction and the sub-scanning direction; and
a controller configured to control said light source, said scanner, said mask stage and said processing stage, the width of said second mask pattern being narrower than that of said first mask pattern by a length corresponding to a ringing appearing in the pattern beam, said controller carrying out a laser ablation in a processing area of said workpiece repeatedly to form a processed pattern with a flat bottom in the processing area by controlling said mask stage and said processing stage.

11. A method for processing a workpiece by laser ablation, comprising:
a) preparing a mask with a plurality of mask patterns, said plurality of mask patterns having widths between pattern edges intersecting a direction corresponding to a sub-scanning direction, the widths of said plurality of mask patterns being different from one another, said plurality of mask patterns being geometrically similar to one another;
b) scanning a line-shaped laser beam over said mask;
c) projecting a pattern beam that passes through said mask onto a workpiece; and
d) processing a processing area of said workpiece by using said plurality of mask patterns repeatedly to form a processed pattern with a flat bottom the processing area.
